(19) United States
(12) Patent Application Publication
(10) Pub. No.: US 2012/0171426 A1
(43) Pub. Date: Jul. 5, 2012

(54) Stand-Up Elastic Bands and Methods of Making and Using the Same

(76) Inventor: T. Kevin Vick, Thomasville, GA (US)

(21) Appl. No.: 13/287,354

(22) Filed: Nov. 2, 2011

Related U.S. Application Data
(60) Provisional application No. 61/409,909, filed on Nov. 3, 2010.

(51) Int. Cl. B32B 3/00

(52) U.S. Cl. 428/156

(57) ABSTRACT

Stand-up or piggy-back elastic bands are disclosed. Methods of making and using stand-up or piggy-back elastic bands are also disclosed.

### CROSS-REFERENCE TO RELATED APPLICATIONS

This patent application claims the benefit of priority to U.S. Provisional Patent Application Ser. No. 61/409,909 filed on Nov. 3, 2010 and entitled “STAND-UP ELASTIC BANDS AND METHODS OF MAKING AND USING THE SAME,” the subject matter of which is hereby incorporated by reference in its entirety.

### TECHNICAL FIELD

The present invention relates to stand-up elastic bands (also referred to herein as “piggy-back” elastic bands), methods of making such stand-up elastic bands, and methods of using such stand-up elastic bands.

### BACKGROUND

Many elastic bands are currently available to a user. SILLYBANDZ™ brand elastic bands are one example of commercially available elastic band. SILLYBANDZ™ brand elastic bands have a relatively simple structure, typically comprising a single continuous loop of elastic material formed into an object shape.

Another commercially available elastic band is sold under the trade designation MONKEY BANDS. See, for example, the article at the following website http://www.animalbraceletsblog.com/animal-bracelets-blog/2010/06/monkey-bands-pass-one-million-packs-soid.html. The disclosed elastic bands comprise an overall shape in the form of a monkey with (i) a continuous elastic band forming the body of the monkey (i.e., the head and torso of the monkey) and (ii) molded components extending outward from the continuous elastic band forming the appendages and tail of the monkey (i.e., the arms, legs and tail of the monkey).

As noted by the above exemplary commercially available elastic bands, the consumer is provided with many choices when it comes to deciding which elastic band(s) to purchase.

Efforts continue in the development of elastic bands that (1) provide one or more unique features, (2) are relatively easy to manufacture and use, (3) provide an aesthetically pleasing look for the user and other viewers, and (4) are economical to make and use.

### SUMMARY

The present invention continues the effort to develop elastic bands that (1) provide one or more unique features, (2) are relatively easy to manufacture and use, (3) provide an aesthetically pleasing look for the user and other viewers, and (4) are economical to make and use. The present invention is directed to “stand-up” elastic bands or “piggy-back” elastic bands as described and shown herein.

In one exemplary embodiment, the elastic band of the present invention comprises (i) a continuous elastic band having a band shape, a band outer surface, a band inner surface, and a band cross-sectional shape, wherein the band shape comprises (or consists of) a first complete object shape; and at least one piggy-back member integrally attached to and extending from the band outer surface, wherein each piggy-back member independently comprises (or consists of) a piggy-back member shape, and a piggy-back member cross-sectional shape, wherein the piggy-back member shape comprises (or consists of) a second complete object shape that provides identification of the first complete object shape to a viewer. Typically, a given elastic band of the present invention comprises (i) the continuous elastic band; and (ii) a single piggy-back member integrally attached to and extending from an outer surface of the continuous elastic band.

In another exemplary embodiment, the elastic band of the present invention comprises (i) a single continuous loop of elastomeric material forming a first object shape; and (ii) at least one piggy-back member integrally attached to and extending from an outer surface of the single continuous loop, wherein each piggy-back member independently comprises a piggy-back member shape comprising (or consisting of) one or more loops of piggy-back member material forming a second object shape, wherein the first object shape is substantially identical to the second object shape.

In yet another exemplary embodiment, the elastic band of the present invention comprises (or consists of) (i) a single continuous loop of elastomeric material forming a first object shape; and (ii) a single piggy-back member integrally attached to and extending from an outer surface of the single continuous loop, wherein the piggy-back member comprises (or consists of) a piggy-back member shape comprising (or consisting of) one or more loops of piggy-back member material forming a second object shape, wherein the first object shape is substantially identical to the second object shape.

The present invention is further directed to methods of making the disclosed elastic bands and methods of using the disclosed elastic bands. In one exemplary embodiment, the method of making an elastic band of the present invention comprises thermoforming an elastomeric material into a thermoformed shape comprising (i) a continuous elastic band having a band shape, a band outer surface, a band inner surface, and a band cross-sectional shape, wherein the band shape comprises (or consists of) a first complete object shape; and (ii) at least one piggy-back member integrally attached to and extending from the band outer surface, wherein each piggy-back member independently comprises a piggy-back member shape and a piggy-back member cross-sectional shape, wherein the piggy-back member shape comprises (or consists of) a second complete object shape that provides identification of the first complete object shape to a viewer. Typically, the thermoformed shape comprises (or consists of) (i) a single continuous elastic loop having a desired band shape in the form of a first complete object shape (e.g., a letter of the alphabet); and (ii) a single piggy-back member integrally attached to and extending from an outer surface of the single continuous elastic loop, wherein the single piggy-back member comprises (or consists of) one or more loops of piggy-back member material with the one or more loops of piggy-back member material forming a desired shape in the form of a second complete object shape (e.g., an identical letter of the alphabet as shown by the single continuous elastic loop, but much smaller relative to the single continuous elastic loop, i.e., a miniature version of the first complete object shape).

When in use, the continuous elastic band fits over a user's body part (e.g., a user's wrist or ankle), and typically fits relatively snugly over the body part such that the original shape of the continuous elastic band (i.e., the first complete object shape) converts into a shape that fits snugly over the body part (e.g., an oval shape), while the one or more piggy-back members (i.e., the one or more second complete object shapes) attached to the continuous elastic band extend upward and substantially orthogonal to the user's body part (e.g., a user's wrist or ankle) so as to “stand up” relative to the user's body part (e.g., a user's wrist or ankle). Once removed from the user's body part (e.g., a user's wrist or ankle) and provided in a tensionless state, the continuous elastic band returns substantially to its original shape (i.e., the first complete object shape).

These and other features and advantages of the present invention will become apparent after a review of the following detailed description of the disclosed embodiments and the appended claims.

### BRIEF DESCRIPTION OF THE DRAWINGS

The present invention is further described with reference to the appended figures, wherein:

FIG. 1 depicts a frontal view of an exemplary elastic band of the present invention;

FIG. 2 depicts a side view of the exemplary elastic band of FIG. 1 as view in direction “A” shown in FIG. 1;

FIG. 3 depicts a cross-sectional view of an exemplary cross-section of a continuous elastic band component of the exemplary elastic band of FIG. 1 as view along cross-section “B-B” shown in FIG. 1;

FIG. 4 depicts a cross-sectional view of an exemplary cross-section of a piggy-back member component of the exemplary elastic band of FIG. 1 as view along cross-section “C-C” shown in FIG. 1;

FIGS. 5-6 depict various exemplary elastic bands of the present invention;

FIG. 7 depicts various exemplary elastic bands of the present invention in use, for example, on a user's arm; and

FIG. 8 depicts a combination of various exemplary elastic bands of the present invention in use, for example, on a user's arm so as to form a string of letters.

### DETAILED DESCRIPTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

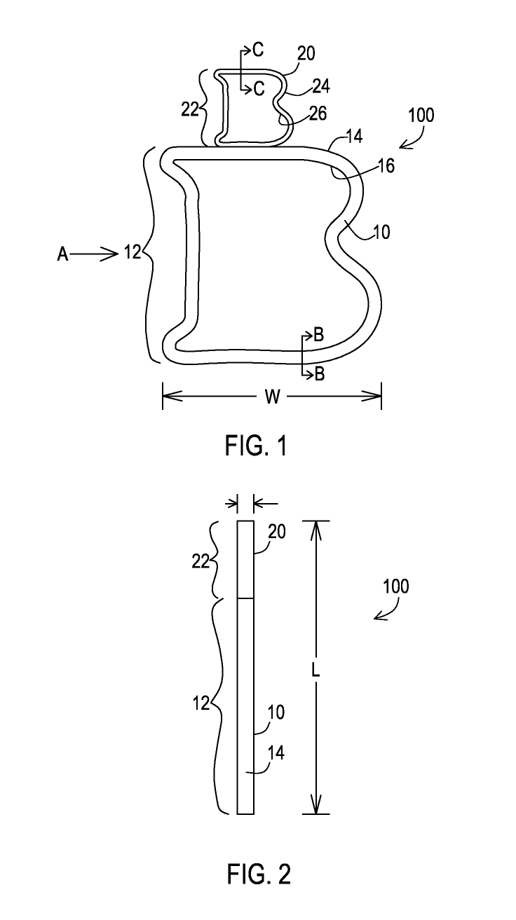

The present invention is directed to elastic bands suitable for extending over a user's extremity such as a wrist, an arm, an ankle, a leg, a neck, etc. as shown in FIGS. 1-8, and as described in the claims below. As used herein, the term “complete object shape” refers to a shape that is intended to represent all of an object (e.g., all of an animal or all of a letter of the alphabet), as oppose just a portion of an object. For example, as discussed above, MONKEY BANDS brand elastic bands represent a complete object shape in the form of a monkey, and consequently, represent a single complete object shape (i.e., the continuous elastic band and molded components extending from the continuous elastic loop together represent a single monkey, i.e., a single complete object shape). In contrast, the elastic bands of the present invention represent at least two complete object shapes: (1) a first complete object shape formed by the continuous elastic loop portion of the elastic bands of the present invention, and (2) one or more second complete object shapes represented by the one or more piggy-back members attached to the continuous elastic band and extending upward and substantially orthogonal to a user's body part (e.g., a user's wrist or ankle) when in use. Consequently, an elastic band of the present invention, having a shape in the form of a monkey, might comprise (1) a first complete object shape in the form of a monkey formed by the continuous elastic loop portion of the elastic band of the present invention, and (2) one or more second complete object shapes represented by the one or more piggy-back members attached to the continuous elastic band and extending upward and substantially orthogonal to a user's body part (e.g., a user's wrist or ankle) when in use, wherein the one or more second complete object shapes represented by the one or more piggy-back members are in the form of (i) a complete monkey substantially similar or identical to the first complete object shape in the form of a monkey (typically, a miniature version), (ii) a complete banana (typically, a miniature version), or (iii) a combination of (i) and (ii).

As used herein, the term “complete object shape” does not encompass a portion of a complete object. For example, “complete object shape” would not refer to a head and/or torso of an animal, but would instead refer to the complete animal.

As used herein, the term “multi-sided shape” refers to a shape comprising three or more sides (e.g., a triangular shape having three sides, a square shape having four sides, etc.). The term “multi-sided shape” also refers to complex shapes that comprise one or more straight sides, one or more curved sides, or any combination thereof.

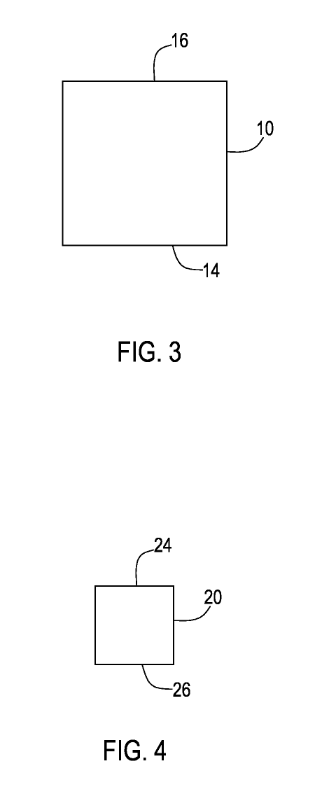

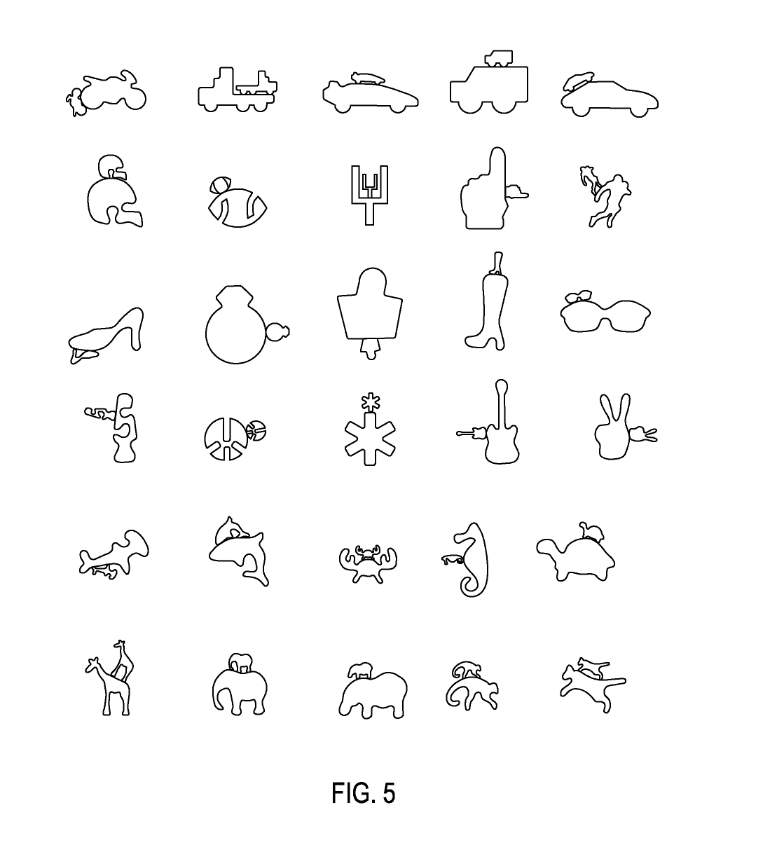

An exemplary elastic band of the present invention is shown in FIG. 1. As shown in FIG. 1, exemplary elastic band 100 comprises a continuous elastic band 10 having a band shape 12 in the form of a first complete object shape (i.e., the letter “B”), a band outer surface 14, a band inner surface 16, and a band cross-sectional shape (shown in FIG. 3); and at least one piggy-back member 20 integrally attached to and extending from band outer surface 14. Each piggy-back member 20 independently comprises a piggy-back member shape 22 in the form of a second complete object shape (i.e., a miniature version of the letter “B”), and a piggy-back member cross-sectional shape (shown in FIG. 4). Further, each piggy-back member 20 independently comprises a piggy-back member outer surface 24, and a piggy-back member inner surface 26.

FIG. 2 provides a side view of exemplary elastic band 100 of FIG. 1 as view in direction “A” shown in FIG. 1. As shown in FIG. 2, exemplary elastic band 100 has an overall thickness t that is substantially smaller in dimension that an overall length L. Further, continuous elastic band 10 has overall dimensions (i.e., a sum of a thickness, length and width) that are greater than overall dimensions of piggy-back member 20.

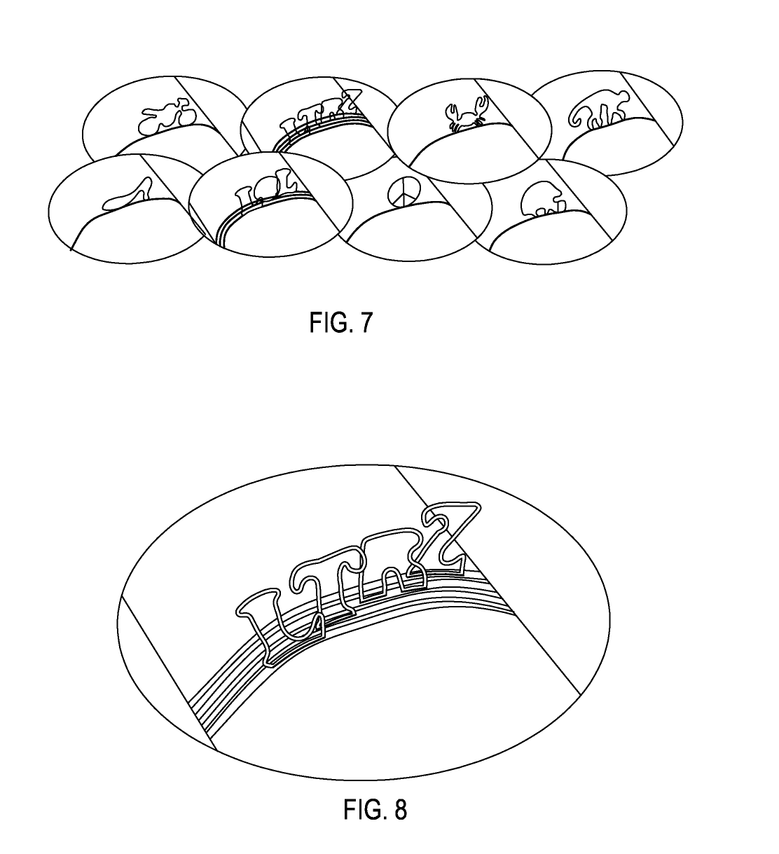

As shown in FIGS. 1-2 (and as also illustrated by various elastic bands of the present invention in FIGS. 7-8 discussed below), exemplary piggy-back member 20 “stands up” along band outer surface 14. Further, as shown in FIGS. 1-2 (and as also illustrated by various elastic bands of the present invention in FIGS. 7-8 discussed below), exemplary piggy-back member 20 identifies or suggests an identification of exemplary continuous elastic band 10. In exemplary elastic band 100, piggy-back member 20 identifies exemplary continuous elastic band 10 as the letter “B” and enables continued identification of exemplary continuous elastic band 10 even during use (i.e., when exemplary continuous elastic band 10 is slightly distorted when placed around a body part having a relatively small outer periphery (e.g., a small child's wrist) or stretched when placed around a body part having a relatively large outer periphery (e.g., a larger child's wrist or an adult's wrist).

Although there are no limitations of the actual size of elastic bands of the present invention, elastic bands of the present invention typically have an overall width w (as shown in FIG. 1) of up to about 10 centimeters (cm) (more typically, from about 4.0 to about 7.0 cm), an overall length L of up to about 10 cm (more typically, from about 4.0 to about 7.0 cm), and an overall thickness t of up to about 10 millimeters (mm) (more typically, from about 2.0 to about 5.0 mm). Continuous elastic band 10 typically has an overall width w of up to about 8.0 centimeters (cm) (more typically, from about 4.0 to about 6.0 cm), an overall length L of up to about 8.0 cm (more typically, from about 4.0 to about 6.0 cm), and an overall thickness t of up to about 10 mm (more typically, from about 2.0 to about 5.0 mm). Each piggy-back member 20 typically has an overall width w of up to about 2.0 centimeters (cm) (more typically, from about 1.0 to about 1.5 cm), an overall length L of up to about 2.0 cm (more typically, from about 1.0 to about 1.5 cm), and an overall thickness t of up to about 10 mm (more typically, from about 2.0 to about 5.0 mm).

As further shown in FIG. 2, piggy-back member 20 extends away from band inner surface 16 (i.e., “stands up” when not in use and during use). In addition, continuous elastic band 10 and piggy-back member 20 are substantially within a plane extending vertically and orthogonal to the page.

FIG. 3 depicts a cross-sectional view of an exemplary cross-section of continuous elastic band 10 of exemplary elastic band 100 of FIG. 1 as view along cross-section “B-B” shown in FIG. 1. As shown in FIG. 3, continuous elastic band 10 of exemplary elastic band 100 has an exemplary cross-sectional shape in the form of a square. It should be noted that continuous elastic band 10 of exemplary elastic band 100 can have any other cross-sectional shape. Suitable cross-sectional shapes include, but are not limited to, a circle, a tear-drop, a square, a diamond, a triangle, a rhombus, a star, an oval, a hexagon, a rectangle, a parallelogram, or any other multi-sided shape.

FIG. 4 depicts a cross-sectional view of an exemplary cross-section of piggy-back member 20 of exemplary elastic band 100 of FIG. 1 as view along cross-section “C-C” shown in FIG. 1. As shown in FIG. 4, piggy-back member 20 of exemplary elastic band 100 has an exemplary cross-sectional shape in the form of a square. It should be noted that piggy-back member 20 of exemplary elastic band 100 can have any other cross-sectional shape. Suitable cross-sectional shapes include, but are not limited to, the cross-sectional shapes discussed above with reference to continuous elastic band 10.

In one exemplary embodiment, the band cross-sectional shape and the piggy-back member cross-sectional shape are each independently selected from shapes comprising a circle, a tear-drop, a square, a diamond, a triangle, a rhombus, a star, an oval, a hexagon, a rectangle, a parallelogram, or any other multi-sided shape. In other exemplary embodiments, the band cross-sectional shape and the piggy-back member cross-sectional shape are each independently selected from shapes comprising a circle, a square, an oval, or a rectangle. In even further exemplary embodiments, the band cross-sectional shape and the piggy-back member cross-sectional shape are substantially similar to one another, and each comprise a shape comprising a square.

Although exemplary elastic band 100 of FIG. 1 is shown having a “B” letter shape, it should be noted that the band shape (i.e., the shape of continuous elastic band 10 in the form of a first complete object shape) and the piggy-back member shape (i.e., the shape of piggy-back member 20 in the form of a second complete object shape) may comprise any possible complete object shape. Suitable possible complete object shapes for the band shape (i.e., the shape of continuous elastic band 10 in the form of a first complete object shape) and each piggy-back member shape (i.e., the shape of piggy-back member 20 in the form of a second complete object shape) include, but are limited to, complete object shapes comprising an alphabet letter, an animal, a vehicle, a peace sign, a musical instrument, an article of clothing, a sport component, a team emblem, a piece of furniture, or any combination thereof.

In some exemplary embodiments, such as exemplary elastic band 100 of FIG. 1, the band shape (i.e., the shape of continuous elastic band 10 in the form of a first complete object shape) and the piggy-back member shape (i.e., the shape of piggy-back member 20 in the form of a second complete object shape) are substantially similar to one another. However, it should be noted that the band shape (i.e., the shape of continuous elastic band 10 in the form of a first complete object shape) and the piggy-back member shape (i.e., the shape of piggy-back member 20 in the form of a second complete object shape) may have different shapes.

In desired embodiments, the piggy-back member shape (i.e., the shape of piggy-back member 20 in the form of a second complete object shape) provides identification of the band shape (i.e., the shape of continuous elastic band 10 in the form of a first complete object shape) to a viewer. As used herein, the phrase “provides identification of the band shape (i.e., the shape of continuous elastic band 10 in the form of a first complete object shape) to a viewer” and the phrase “provides identification of the first complete object shape” to a viewer refer to the ability of a viewer of a given piggy-back member shape (i.e., the shape of piggy-back member 20 in the form of a second complete object shape) to know the shape of the continuous elastic band component (i.e., the shape of continuous elastic band 10 in the form of a first complete object shape) even when stretched during use on a user's body part (e.g., a user's wrist or ankle). Unlike known, commercially available elastic bands, the elastic bands of the present invention enable a user and any viewers of the user's elastic band to identify the overall shape of the elastic band by the piggy-back member shape (i.e., the shape of piggy-back member 20 in the form of a second complete object shape).

Even when the band shape (i.e., the shape of continuous elastic band 10 in the form of a first complete object shape) and the piggy-back member shape (i.e., the shape of piggy-back member 20 in the form of a second complete object shape) comprise different shapes, the piggy-back member shape (i.e., the shape of piggy-back member 20 in the form of a second complete object shape) provides some degree of certainty as to the band shape (i.e., the shape of continuous elastic band 10 in the form of a first complete object shape) due to the correlation between a given piggy-back member shape (i.e., the shape of piggy-back member 20 in the form of a second complete object shape) (e.g., a second complete object shape in the form of a banana) and the band shape (i.e., the shape of continuous elastic band 10 in the form of a first complete object shape) (e.g., a first complete object shape in the form of a monkey).

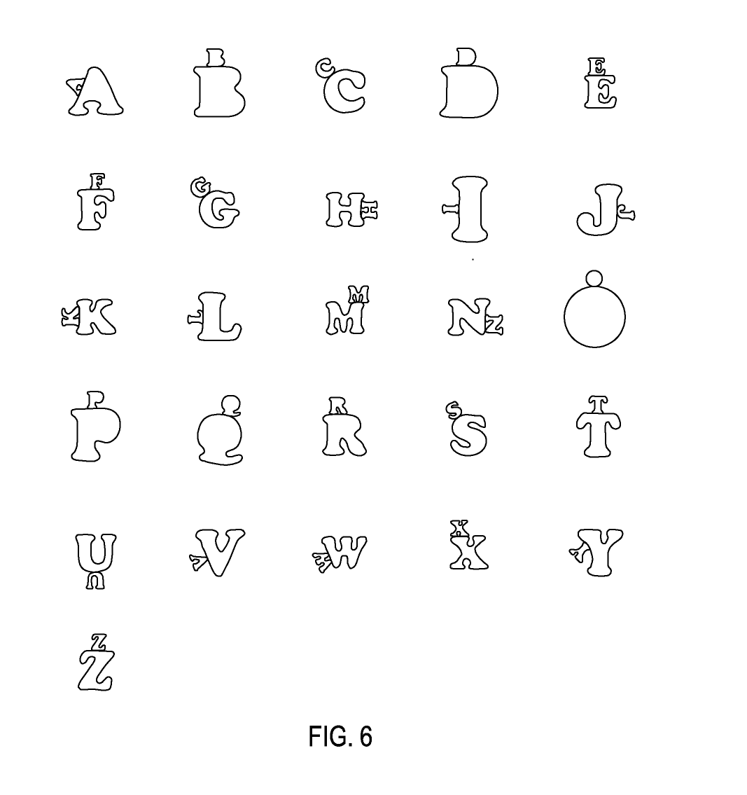

FIGS. 5-6 depict various exemplary elastic bands of the present invention having a variety of first and second complete object shapes. As shown in FIGS. 5-6, exemplary elastic bands of the present invention may have a variety of overall shapes. In some exemplary embodiments, the continuous elastic band 10 comprises (or consists of) a single continuous loop of elastomeric material in the form of a first complete object shape, while each piggy-back member (e.g., piggy-back member 20) independently comprises (or consists of) one or more loops of piggy-back member material in the form of a second complete object shape. For example, exemplary elastic band 100 of FIG. 1 consists of a single continuous loop of elastomeric material in the form of a first complete object shape, while piggy-back member 20 consists of a single loop of piggy-back member material in the form of a second complete object shape.

In other exemplary embodiments, elastic bands of the present invention comprise (or consist of) a continuous elastic band comprising (or consisting of) a single continuous loop of elastomeric material in the form of a first complete object shape, and each piggy-back member independently comprises (or consists of) two or more loops of piggy-back member material in the form of a second complete object shape. Examples of this type of elastic band include, but are not limited to, elastic bands wherein each piggy-back member comprises (or consists of) a shoe shape, a sunglasses shape, and the letter “H.”

In other exemplary embodiments, elastic bands of the present invention comprise (or consist of) a continuous elastic band comprising (or consisting of) a single continuous loop of elastomeric material in the form of a first complete object shape, and each piggy-back member independently comprises (or consists of) three or more loops of piggy-back member material in the form of a second complete object shape. Examples of this type of elastic band include, but are not limited to, elastic bands wherein each piggy-back member comprises (or consists of) a football shape, a flat-bed truck shape, and the letter “M.”

In yet other exemplary embodiments, elastic bands of the present invention comprise (or consist of) a continuous elastic band comprising (or consisting of) a single continuous loop of elastomeric material in the form of a first complete object shape, and each piggy-back member independently comprises (or consists of) four or more loops of piggy-back member material in the form of a second complete object shape. Examples of this type of elastic band include, but are not limited to, elastic bands wherein each piggy-back member comprises (or consists of) a peace sign shape, a giraffe shape, and a monkey shape.

The present invention is further directed to methods of making the elastic bands, wherein the elastic bands comprise one or more of the features described above. Methods of making the elastic bands of the present invention may include, but are not limited to, one or more of the following method steps: thermoforming (e.g., injection molding, blow molding, etc.) an elastic band; removing an elastic band from a mold; combining one or more elastic bands to form a kit; and packaging one or more elastic bands in a packaging material.

Any thermoformable material may be utilized to form the elastic bands of the present invention as long as the resulting elastic band has a degree of elasticity that enables the elastic band to be stretched so as to be placed onto a user's body part (e.g., a user's wrist or ankle). Typically, the material used to form the continuous elastic band (e.g., continuous elastic band 10) and each piggy-back member shape (e.g., piggy-back member 20) is identical. However, in some embodiments, the material used to form the continuous elastic band (e.g., continuous elastic band 10) may be different from the material used to form each piggy-back member shape (e.g., piggy-back member 20). For example, the material used to form the continuous elastic band (e.g., continuous elastic band 10) may comprise a material having a greater degree of elasticity (e.g., a silicone rubber) compared to the material used to form each piggy-back member shape (e.g., a polypropylene).

Suitable materials for forming the continuous elastic band (e.g., continuous elastic band 10) and each piggy-back member shape (e.g., piggy-back member 20) include, but are not limited to, a synthetic rubber, a silicone rubber, a ethylene-propylene copolymer, etc. In desired embodiments, the material used to form the continuous elastic band (e.g., continuous elastic band 10) and each piggy-back member shape (e.g., piggy-back member 20) comprises silicone rubber.

The present invention is even further directed to methods of using any of the above-described elastic bands. Methods of using any of the elastic bands of the present invention may include, but are not limited to, one or more of the following steps: stretching a continuous elastic band component of a given elastic band so as to be stretched to a size that fits over a user's body part (e.g., a user's hand or foot); sliding the elastic band over a user's body part (e.g., a user's hand or foot) so as to be positioned along a user's body part (e.g., a user's wrist or ankle); positioning multiple elastic band along a user's body part (e.g., a user's wrist or ankle); and removing one or more elastic bands from a user's body part (e.g., a user's wrist or ankle).

FIG. 7 depicts various exemplary elastic bands of the present invention in use, for example, on a user's arm. As shown in FIG. 7, when in use, each elastic band of the present invention fits over a user's body part (e.g., a user's wrist or ankle), and in some cases (e.g., a band having a small diameter or a user having a relatively large body part diameter), fits relatively snugly over the body part such that the original shape of the continuous elastic band converts into a shape that fits snugly over the body part (e.g., an oval shape), while the one or more piggy-back member attached to the continuous elastic band extend upward and substantially orthogonal to the user's body part (e.g., a user's wrist or ankle). For example, the elastic band comprising a peace sign is shown in FIG. 5 (i.e., row 4, column 2) in a tensionless state, while FIG. 7 shows the same elastic band in use (i.e., the picture in row 2, column 3).

As shown in FIG. 7, the original shape of the continuous elastic band (e.g., continuous elastic band 10) in the form of a peace sign converts to a shape that conforms to the user's body part (e.g., a user's wrist or ankle), while the piggy-back member (e.g., piggy-back member 20) maintains the form of a peace sign.

Although not shown in the figures, the original shape of the continuous elastic band (e.g., continuous elastic band 10) may only be slightly distorted (or not distorted at all) in cases where the user's body part dimensions (e.g., wrist) is small relative to a diameter (or smallest dimension) of the original shape of the continuous elastic band (e.g., continuous elastic band 10). Even in these cases, the piggy-back member (e.g., piggy-back member 20) maintains the form of a peace sign in a “stand up” configuration relative to the continuous elastic band (e.g., continuous elastic band 10).

Once removed from the user's body part (e.g., a user's wrist or ankle) and allowed to return to a tensionless state, the continuous elastic band (e.g., continuous elastic band 10) returns substantially to its original shape.

FIG. 8 depicts a combination of various exemplary elastic bands of the present invention in use, for example, on a user's arm so as to form a string of letters. It should be noted that any combination of elastic bands may be used to form a unique string of shapes.

The present invention is even further directed to kits comprising two or more elastic bands, wherein at least one elastic band in the kit comprises one of the above-described elastic bands of the present invention. In some embodiments, the kit comprises two or more elastic bands, wherein at least two elastic bands in the kit each independently comprise two above-described elastic bands of the present invention.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. An elastic band comprising:
a continuous elastic band having a band shape, a band outer surface, a band inner surface, and a band cross-sectional shape, wherein said band shape consists of a first complete object shape; and
at least one piggy-back member integrally attached to and extending from said band outer surface, wherein each piggy-back member independently comprises a piggy-back member shape, and a piggy-back member cross-sectional shape, wherein said piggy-back member shape consists of a second complete object shape that provides identification of said first complete object shape to a viewer.

2. The elastic band of claim 1, wherein each piggy-back member extends away from said band inner surface.

3. The elastic band of claim 1, wherein said continuous elastic band and said at least one piggy-back member are within a plane.

4. The elastic band of claim 1, wherein said elastic band has an overall thickness of less than about 12 millimeters (mm).

5. The elastic band of claim 1, wherein said continuous elastic band has overall dimensions that are greater than overall dimensions of any individual piggy-back member.

6. The elastic band of claim 1, wherein said first complete object shape and said second complete object shape are each independently selected from shapes comprising an alphabet letter, an animal, a vehicle, a peace sign, a musical instrument, an article of clothing, a sport component, a team emblem, a piece of furniture, or any combination thereof.

7. The elastic band of claim 1, wherein said first complete object shape and said second complete object shape are substantially similar to one another.

8. The elastic band of claim 1, wherein said band cross-sectional shape and said piggy-back member cross-sectional shape are each independently selected from shapes comprising a circle, a tear-drop, a square, a diamond, a triangle, a rhombus, a star, an oval, a hexagon, a rectangle, a parallelogram, or any other multi-sided shape.

9. The elastic band of claim 8, wherein said band cross-sectional shape and said piggy-back member cross-sectional shape are each independently selected from shapes comprising a circle, a square, an oval, or a rectangle.

10. The elastic band of claim 1, wherein said band cross-sectional shape and said piggy-back member cross-sectional shape are substantially similar to one another.

11. The elastic band of claim 10, wherein said band cross-sectional shape and said piggy-back member cross-sectional shape are both a square shape.

12. The elastic band of claim 1, wherein said continuous elastic band consists of a single continuous loop of elastomeric material forming said first complete object shape, and each piggy-back member independently consists of one or more loops of piggy-back member material forming said second complete object shape.

13. The elastic band of claim 1, wherein said continuous elastic band consists of a single continuous loop of elastomeric material forming said first complete object shape, and each piggy-back member independently consists of one loop of piggy-back member material forming said second complete object shape.

14. The elastic band of claim 1, wherein said continuous elastic band consists of a single continuous loop of elastomeric material forming said first complete object shape, and each piggy-back member independently consists of two or more loops of piggy-back member material forming said second complete object shape.

15. The elastic band of claim 12, wherein said elastomeric material and said piggy-back member material are identical.

16. The elastic band of claim 15, wherein said elastomeric material and said piggy-back member material each comprise a silicone rubber.

17. The elastic band of claim 1, wherein said at least one piggy-back member comprises a single piggy-back member.

18. An elastic band comprising:
a single continuous loop of elastomeric material forming a first object shape; and
at least one piggy-back member integrally attached to and extending from an outer surface of said single continuous loop, wherein each piggy-back member independently comprises a piggy-back member shape consisting of one or more loops of piggy-back member material forming a second object shape,
wherein said first object shape is substantially identical to said second object shape.

19. The elastic band of claim 18, wherein said elastic band consists of said single continuous loop of elastomeric material, and said at least one piggy-back member consists of a single piggy-back member.

20. The elastic band of claim 19, wherein said second object shape is a miniature version of said first object shape.
